(19) United States
(12) Patent Application Publication
(10) Pub. No.: US 2026/0081198 A1
(43) Pub. Date: Mar. 19, 2026

(54) SECONDARY BATTERY STACKING DEVICE AND METHOD FOR STACKING SECONDARY BATTERY

(71) Applicant: SAMSUNG SDI CO., LTD., Yongin-Si Gyeonggi-do (KR)

(72) Inventors: Heonhee Kim, Yongin-Si Gyeonggi-do (KR); Bo Hyun Kim, Yongin-Si Gyeonggi-do (KR); Jinhyeong Jo, Yongin-Si Gyeonggi-do (KR); Minju Kim, Yongin-Si Gyeonggi-do (KR); Seungyeol Yoo, Yongin-Si Gyeonggi-do (KR); Hyeokjoo Kim, Yongin-Si Gyeonggi-do (KR); Bohun Kim, Yongin-Si Gyeonggi-do (KR); Duckhyun Kim, Yongin-Si Gyeonggi-do (KR); Woonsuk Jang, Yongin-Si Gyeonggi-do (KR)

(21) Appl. No.: 19/089,713

(22) Filed: Mar. 25, 2025

(30) Foreign Application Priority Data
Sep. 13, 2024 (KR) 10-2024-0125884

(51) Int. Cl. H01M 10/04

(52) U.S. Cl. CPC H01M 10/0404; H01M 10/0468

(57) ABSTRACT

The present disclosure provides a secondary battery stacking device. The secondary battery stacking device includes a stacking table configured to position a reel on the stacking table, a ladder frame positioned above the stacking table and having a guide rail along a longitudinal direction, a rotary gripper configured to suction the reel and move the reel along the guide rail, and a reel supply portion configured to supply the reel.

### CROSS-REFERENCE TO RELATED APPLICATION

The present application claims priority to and the benefit under 35 U.S. C § 119(a)-(d) of Korean Application No. 10-2024-0125884, filed in the Korean Intellectual Property Office on Sep. 13, 2024, the entire disclosure of which is incorporated herein by reference.

### BACKGROUND

### Technical Field

The present disclosure relates to a secondary battery stacking device and a method for stacking a secondary battery.

### Description of the Related Art

While primary batteries are not designed to be (re)charged, secondary (also known as rechargeable) batteries are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

Secondary batteries include a positive electrode plate, a separator, and a negative electrode plate sequentially stacked and immersed in an electrolyte solution. Typically, there exist two types of methods for manufacturing the internal cell stack. For small-sized secondary batteries, a negative electrode plate and a positive electrode plate are positioned on a separator and rolled (wound) to produce a jelly-roll shape. For medium-sized and large-sized secondary batteries with greater electric capacity, the negative electrode plate, the positive electrode plate, and the separator are stacked in an appropriate order. The stacking process involves costly investment and requires high-speed, high-precision processes.

The information disclosed in this Background section is for enhancement of understanding of the background of the present disclosure. The section may contain information that does not constitute related (or prior) art.

### SUMMARY

Aspects of embodiments of the present disclosure provide a secondary battery stacking device and a method for stacking a secondary battery.

Embodiments of the present disclosure provide a secondary battery stacking device including a stacking table on which a reel is positioned, a ladder frame positioned above the stacking table and having a guide rail formed along a longitudinal direction, a rotary gripper configured to suction the reel and move along the guide rail and a reel supply portion configured to supply the reel that is transferred to one end of the ladder frame.

Embodiments of the present disclosure provide secondary battery stacking device, including: a stacking table configured to position a reel on the stacking table; a ladder frame positioned above the stacking table and comprising a guide rail along a longitudinal direction; a rotary gripper configured to suction the reel and move the reel along the guide rail; and a reel supply portion configured to supply the reel.

According to an embodiment, the latter frame may include a base portion in which the guide rail may be formed along an inner end and a plurality of bridge portions positioned above the stacking table and spaced apart from the base portion.

In an embodiment, the ladder frame further includes: a base portion supporting the guide rail; and a plurality of bridge portions positioned above the stacking table and spaced apart at predetermined intervals in the longitudinal direction.

According to an embodiment, the rotary gripper may include a gripper body portion having a guide groove into which the guide rail is inserted and a suction portion positioned on one side of the gripper body portion and configured to suction the reel.

In an embodiment, the rotary gripper includes: a gripper body portion comprising a guide groove corresponding to the guide rail; and a suction portion positioned on one side of the gripper body portion and configured to suction the reel.

According to an embodiment, the gripper body portion of the rotary gripper may be configured to move along the guide rail to transfer the reel suctioned by the suction portion to one end of the ladder frame, and the gripper body portion of the rotary gripper may be configured to rotate along the guide rail so that the gripper body portion is restored to another end of the ladder frame in a state in which the suction of the real is released from the suction portion.

In an embodiment, the gripper body portion is configured to move along the guide rail to transfer the reel.

According to an embodiment, may further include a fixing jig connected to opposite ends of the ladder frame in the longitudinal direction and configured to fix opposite ends of the reel in a state in which the reel is absorbed by the rotary gripper and transferred to one end of the ladder frame.

In an embodiment, the secondary battery stacking device further includes a fixing jig connected to longitudinal ends of the ladder frame and configured to fix the longitudinal ends of the reel.

According to an embodiment, may further include a driver connected to the stacking table and configured to apply a driving force to the stacking table and a controller connected to the driver and configured to control a moving distance of the stacking table.

In an embodiment, the secondary battery stacking device further includes: a driver connected to the stacking table and configured to apply a driving force to the stacking table; and a controller connected to the driver and configured to control movement of the stacking table.

According to an embodiment, the controller may be configured to control the driver so that the stacking table moves to a lower end of the ladder frame in response to a thickness of the reel on which a positive electrode plate is stacked.

In an embodiment, the stacking table moves to a lower end of the ladder frame in response to a thickness of the reel on which a positive electrode plate is stacked.

According to an embodiment, may further include an alignment table positioned on one side of the stacking table and configured to adjust positions of a plurality of positive electrode plates transferred from a conveyor on which the positive electrode plates are loaded and a suction jig configured to transfer the positive electrode plates positioned on the alignment table and stack the positive electrode plates on the reel positioned on the stacking table.

In an embodiment, the secondary battery stacking device further includes: an alignment table positioned on one side of the stacking table and configured to adjust positions of a plurality of positive electrode plates transferred from a conveyor; and a suction jig configured to transfer the plurality of positive electrode plates positioned on the alignment table and stack the positive electrode plates on the reel.

According to an embodiment, may further include a first cutting portion positioned above the ladder frame adjacent to the reel supply portion and configured to cut one end of the reel on which a plurality of positive electrode plates are stacked.

In an embodiment, the secondary battery stacking device further includes a first cutting portion positioned above the ladder frame at or adjacent to the reel supply portion and configured to cut the reel having a plurality of positive electrode plates stacked on the reel.

According to an embodiment, may further include a pressurizing jig aligned above the stacking table at a predetermined interval and configured to descend between the bridge portions to pressurize a plurality of positive electrode plates stacked on the reel.

In an embodiment, the secondary battery stacking device further includes a plurality of pressurizing jigs aligned above the stacking table at predetermined intervals and configured to descend between the bridge portions to pressurize a plurality of positive electrode plates stacked on the reel.

According to an embodiment, may further include a second cutting portion aligned above the stacking table at a predetermined interval and configured to descend between the bridge portions to cut the reels at a predetermined interval.

In an embodiment, the secondary battery stacking device further includes a second cutting portion aligned above the stacking table at a predetermined interval and configured to descend between the plurality of bridge portions to cut the reel at a predetermined interval.

Embodiments of the present disclosure provide a secondary battery stacking method including suctioning a reel supplied from a reel supply portion with a rotary gripper, moving the rotary gripper along a guide rail formed on a ladder frame to transfer the reel to one end of a stacking table provided on the ladder frame, transferring a plurality of positive electrode plates to an alignment table, stacking the positive electrode plates on the reel positioned on the stacking table through a plurality of suction jigs, cutting, by a first cutting portion, one end of the reel on which the positive electrode plates are stacked, causing the stacking table to move a lower end of the ladder frame, pressurizing, by a plurality of pressurizing jigs, the positive electrode plates and repeating the suctioning operation to the pressurizing operation.

Embodiments of the present disclosure provide a method for stacking a secondary battery, including: suctioning a reel supplied from a reel supply portion with a rotary gripper; moving the rotary gripper along a guide rail formed on a ladder frame along a longitudinal direction to transfer the reel to one end of a stacking table; transferring a plurality of positive electrode plates to an alignment table; stacking the plurality of positive electrode plates on the reel positioned on the stacking table via a plurality of suction jigs; cutting the reel having the positive electrode plates stacked on the reel; causing the stacking table to move a lower end of the ladder frame; and pressurizing the positive electrode plates.

According to an embodiment, may further include, after the repeating operation, causing a plurality of second cutting portions to descend to cut the reel at predetermined intervals.

In an embodiment, the method further includes causing a plurality of second cutting portions to descend to cut the reel at predetermined intervals.

According to an embodiment, the rotary gripper may include a gripper body portion having a guide groove into which the guide rail is inserted and a suction portion positioned on one side of the gripper body portion and configured to suction the reel.

In an embodiment, the rotary gripper includes: a gripper body portion comprising a guide groove corresponding to the guide rail; and a suction portion positioned on one side of the gripper body portion and configured to suction the reel.

According to an embodiment, the transferring of the reel may include transferring the reel suctioned by the suction portion to one end of the ladder frame by moving the gripper body portion along the guide rail.

In an embodiment, the transferring of the reel includes moving the gripper body portion along the guide rail.

According to an embodiment, may further include causing the gripper body portion to rotate along the guide rail so that the gripper body portion is restored to another end of the ladder frame in a state in which the suction of the real is released from the suction portion.

In an embodiment, the method further includes causing the gripper body portion to rotate along the guide rail.

According to an embodiment, may further include, prior to the operation of cutting one end of the reel, fixing opposite ends of the reel in a state in which the reel is transferred to one end of the ladder frame, through a fixing jig joined to opposite ends of the ladder frame in a longitudinal direction.

In an embodiment, the method further includes fixing longitudinal ends of the reel via a fixing jig joined to longitudinal ends of the ladder frame.

According to an embodiment, in the causing of the stacking table to move to the lower end of the ladder frame, a driver connected to the stacking table may be configured to apply a driving force to the stacking table and a controller connected to the driver may be configured to control a moving distance of the stacking table.

In an embodiment, in the causing, a driver connected to the stacking table applies a driving force to the stacking table and a controller connected to the driver controls movement of the stacking table.

According to an embodiment, in the controlling of the moving distance of the stacking table, the controller may be configured to control the driver so that the stacking table moves to the lower end of the ladder frame in response to a thickness of the reel on which positive electrode plates are stacked.

In an embodiment, the stacking table moves to the lower end of the ladder frame in response to a thickness of the reel on which the plurality of positive electrode plates is stacked.

According to an embodiment, in the pressurizing of the positive electrode plates, the pressurizing jig may be aligned above the stacking table at a predetermined interval and configured to descend between a plurality of bridge portions of the stacking table to pressurize the positive electrode plates stacked on the reel.

In an embodiment, in the pressurizing, a plurality of pressurizing jigs is aligned above the stacking table at predetermined intervals and configured to descend between a plurality of bridge portions of the stacking table to pressurize the plurality of positive electrode plates stacked on the reel.

According to various embodiments of the present disclosure, efficiency may be improved by performing a high-speed, high-precision process in a secondary battery stacking process.

According to various embodiments of the present disclosure, the speed of the process may be improved in a stacking process where a plate in which a negative electrode and a separator are integrally formed or a plate in which a negative electrode and a separator are laminated is used as an object.

According to various embodiments of the present disclosure, during the secondary battery stacking process, in a case where the positive electrode plate is transferred to the alignment table, meandering may be corrected through fine correction, thereby preventing occurrence of a short circuit in the secondary battery.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view showing a secondary battery stacking device according to embodiments of the present disclosure.

FIG. 2 is a perspective view showing a state in which a reel is transferred to one end of a ladder frame in the secondary battery stacking device according to embodiments of the present disclosure.

FIG. 3 is a cross-sectional view taken along line A-A of FIG. 2 and showing a reel being suctioned by a rotary gripper according to embodiments of the present disclosure.

FIG. 4 is a perspective view showing the rotary gripper according to embodiments of the present disclosure.

FIG. 5 shows the rotary gripper moving along the ladder frame according to embodiments of the present disclosure.

FIG. 6 shows a fixing jig according to embodiments of the present disclosure.

FIG. 7 shows the positive electrode plate being transferred to an alignment table in the secondary battery stacking device according to embodiments of the present disclosure.

FIG. 8 shows the positive electrode plate positioned on the alignment table in FIG. 7 being stacked on the reel according to embodiments of the present disclosure.

FIG. 9 shows a first cutting portion in the secondary battery stacking device according to embodiments of the present disclosure.

FIG. 10 shows a pressurizing jig in the secondary battery stacking device according to embodiments of the present disclosure.

FIG. 11 shows a second cutting portion in the secondary battery stacking device according to embodiments of the present disclosure.

FIG. 12 shows an electrode assembly completed by being cut through the second cutting portion of FIG. 11 according to embodiments of the present disclosure.

FIG. 13 shows a plurality of secondary battery stacking devices being arranged according to embodiments of the present disclosure.

FIG. 14 is a flowchart showing a method of stacking a secondary battery according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

The embodiments described herein can be explained with reference to cross-sectional views and/or plain views as example views of the present disclosure. In the drawing, the thicknesses of films and regions can be exaggerated for effective description of technical contents. Thus, regions presented as an example in the drawings have general properties, and shapes of the exemplified areas can be used to illustrate a specific shape of a device region. Therefore, this should not be construed as limited to the scope of the present disclosure. Although the terms such as first, second, and third are used to describe various components in various embodiments herein, the components should not be limited to these terms. These terms are used only to distinguish one component from another component. Embodiments described and exemplified herein include complementary embodiments thereof. Like reference numerals refer to like elements throughout the specification.

As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S. C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

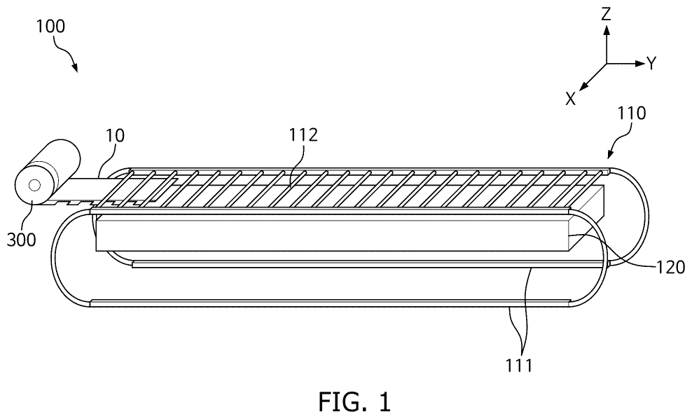

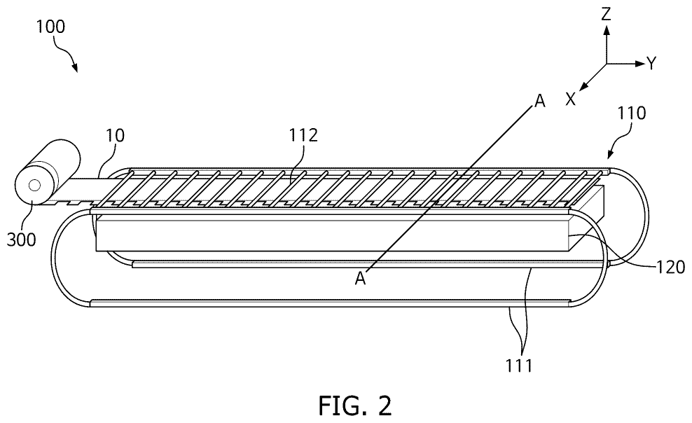

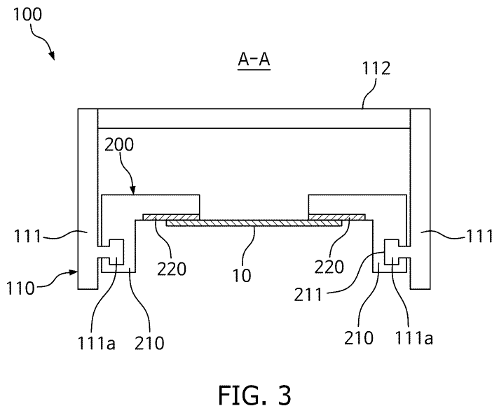

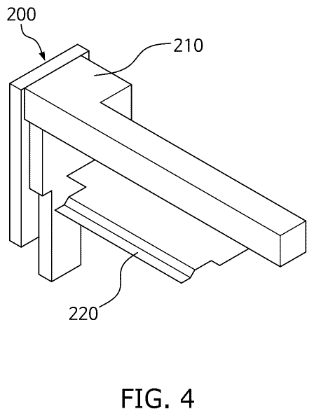

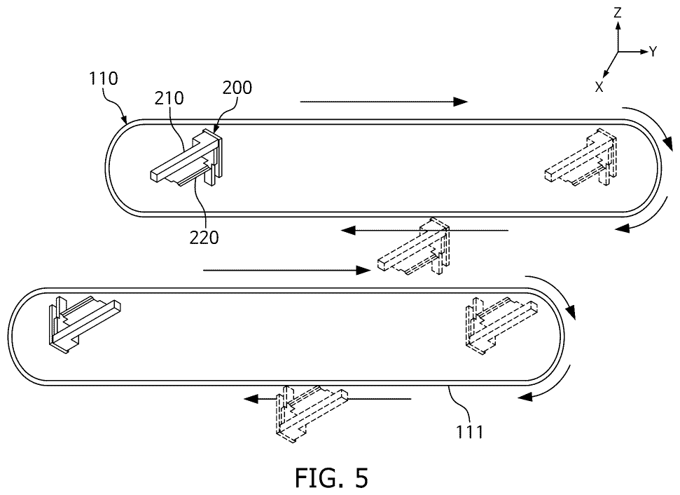

FIG. 1 is a perspective view showing a secondary battery stacking device 100 according to embodiments of the present disclosure, FIG. 2 is a perspective view showing a state in which a reel 10 is transferred to one end of a ladder frame 110 in the secondary battery stacking device 100 according to embodiments of the present disclosure, FIG. 3 is a cross-sectional view taken along line A-A of FIG. 2 and showing a reel 10 being suctioned by a rotary gripper 200 according to embodiments of the present disclosure, FIG. 4 is a perspective view showing the rotary gripper 200 according to embodiments of the present disclosure, and FIG. 5 shows the rotary gripper 200 moving along the ladder frame 110 according to embodiments of the present disclosure.

Referring to FIGS. 1 to 5, the secondary battery stacking device 100 may include a stacking table 120, a ladder frame 110 positioned above the stacking table 120, a rotary gripper 200, and a reel supply portion 300.

In an embodiment, the stacking table 120 may have a reel 10 positioned on the upper surface thereof that may be unwound and supplied from the reel supply portion 300. The stacking table 120 may include a rectangular table extending in the Y-axis direction. The width of the stacking table 120 in the X-axis direction may be greater than the width of the reel 10 in the X-axis direction.

In an embodiment, the ladder frame 110 may be positioned above the stacking table 120 in the Z-axis direction. The ladder frame 110 may have a guide rail 111a formed along the longitudinal direction. In some embodiments, the ladder frame 110 may include a base portion 111 and a bridge portion 112.

The base portion 111 may have the guide rail 111a formed along the inner end thereof. In an embodiment, the guide rail 111a may protrude inwards along the inner end of the base portion 111 in a protruding shape as shown in FIG. 3. The guide rail 111a may be formed along the entire inner end of the base portion 111. The bridge portion 112 may be positioned above the stacking table 120 and may be provided with a plurality of bridge portions spaced apart from the base portion 111. In an embodiment, the bridge portion 112 may include a plurality of bridge portions spaced apart at predetermined intervals in the Y-axis direction.

In an embodiment, the rotary gripper 200 may suctionthe reel 10 and move along the guide rail 111a. The rotary gripper 200 may exist in a pair so as to be respectively joined to a pair of base portions 111. The pair of rotary grippers 200 may suction each side of the reel 10 and move along the guide rail 111a.

The rotary gripper 200 may include a gripper body portion 210 and a suction portion 220. The gripper body portion 210 may have a guide groove 211 into which the guide rail 111a is inserted. In an embodiment, the gripper body portion 210 may be formed with an “L”-shaped cross-section as shown in FIG. 3.

The suction portion 220 may be formed on one side of the gripper body portion 210 and may suctionthe reel 10. In an embodiment, the suction portion 220 may suctionthe upper surface of the reel 10 in the Z-axis direction and may also suctionthe lower surface of the reel 10. When the suction portion 220 suctionsthe reel 10, the gripper body portion 210 may move along the base portion 111 and the reel 10 may move up to one end of the ladder frame 110.

In an embodiment, the gripper body portion 210 of the rotary gripper 200 may move along the guide rail 111a to transfer the reel 10 suctionedby the suction portion 220 to one end of the ladder frame 110. When the suction of the reel 10 is released from the suction portion 220 after the reel 10 is transferred to one end of the ladder frame 110, the rotary gripper 200 may be restored to the other end of the ladder frame 110 by rotating the gripper body portion 210 along the guide rail 111a. The process of positioning the reel 10 on the stacking table 120 and stacking the positive electrode plate may be repeated.

In an embodiment, the reel supply portion 300 may supply the reel 10 to the stacking table 120 while unwinding the reel 10 in the Y-axis direction when the reel 10 is wound. The reel supply portion 300 may release and supply the reel 10 that is wound while rotating about the central axis.

In some embodiments, the reel 10 may have a the negative electrode plate and the separator integrally formed as a single component. In some embodiments, the reel 10 may have the negative electrode plate and the separator laminated.

A negative electrode substrate of the negative electrode plate may include copper foil or nickel foil, and a negative electrode active material may include graphite.

The negative electrode active material may include a material capable of reversibly intercalating/deintercalating lithium ions, a lithium metal, a lithium metal alloy, a material capable of doping/dedoping lithium, or a transition metal oxide.

The material capable of reversibly intercalating/deintercalating lithium ions may include a carbon-based negative electrode active material, such as crystalline carbon, amorphous carbon or a combination thereof. The crystalline carbon may include graphite such as non-shaped, sheet-shaped, flake-shaped, sphere-shaped, or fiber-shaped natural graphite or artificial graphite. The amorphous carbon may include a soft carbon, a hard carbon, a mesophase pitch carbonization product, calcined coke, and the like.

The lithium metal alloy includes lithium and a metal including Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si-based negative electrode active material or a Sn-based negative electrode active material. The Si-based negative electrode active material may include silicon, a silicon-carbon composite, SiOx (0<×<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof) or a combination thereof. The Sn-based negative electrode active material may include Sn, SnO₂, a Sn-based alloy, or a combination thereof.

The silicon-carbon composite may include a composite of silicon and amorphous carbon. According to an embodiment, the silicon-carbon composite may exist in a form of silicon particles and amorphous carbon coated on the surface of the silicon particles. In an embodiment, the silicon-carbon composite may include a secondary particle (core) in which primary silicon particles are assembled, and an amorphous carbon coating layer (shell) on the surface of the secondary particle. The amorphous carbon may also exist between the primary silicon particles, and the primary silicon particles may be coated with the amorphous carbon. The secondary particle may exist dispersed in an amorphous carbon matrix.

The silicon-carbon composite may further include crystalline carbon. In an embodiment, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The positive electrode substrate may include aluminum foil and the positive electrode active material may include a transition metal oxide. The positive electrode active material may include a compound (e.g., lithiated intercalation compound) capable of intercalating and deintercalating lithium. In an embodiment, a composite oxide of lithium and a metal including cobalt, manganese, nickel, and combinations thereof may be used.

The composite oxide may include a lithium transition metal composite oxide. Non-limiting examples of the composite oxide may include lithium nickel-based oxide, lithium cobalt-based oxide, lithium manganese-based oxide, lithium iron phosphate-based compound, cobalt-free nickel-manganese-based oxide, and a combination thereof.

In an embodiment, the composite oxide may include the following compounds represented by any one of the following Chemical Formulas. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α}(0.90≤a≤1.8, 0≤b≤0.5, 0≤c≤0.5, and 0<α<2); LiₐNi_{1-b-c}Mn_{b}X_{c}O_{2-α}D_{α}(0.90≤a≤1.8, 0≤b≤0.5, 0≤c≤0.5, and 0<α<2); LiₐNi_{b}Co_{c}L¹ _{d}GₑO₂ (0.90≤a≤1.8, 0≤b≤0.9, 0≤c≤0.5 , 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8) where A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may include a high nickel-based positive electrode active material having a nickel content of greater than or equal to about 80 mol%, greater than or equal to about 85 mol%, greater than or equal to about 90 mol%, greater than or equal to about 91 mol%, or greater than or equal to about 94 mol%, and less than or equal to about 99 mol% based on 100 mol% of the metal excluding lithium in the lithium transition metal composite oxide. The high-nickel-based positive electrode active material may be capable of realizing high capacity and can be applied to a high-capacity, high-density rechargeable lithium battery.

The separator may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may include a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles including Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

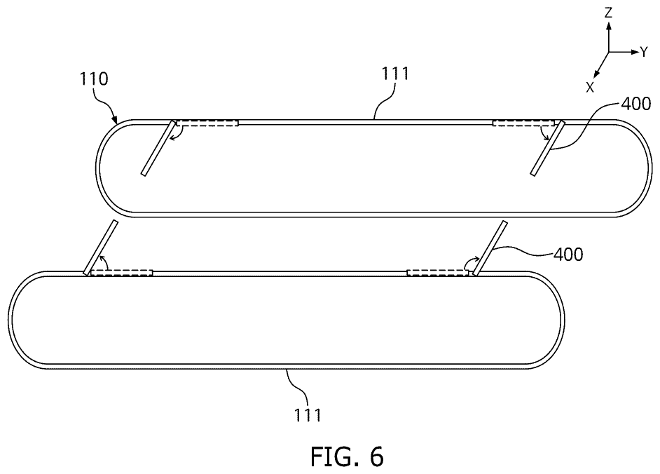

FIG. 6 shows a fixing jig 400 according to embodiments of the present disclosure.

The secondary battery stacking device may further include a fixing jig 400 joined to ends of the ladder frame 110 in the longitudinal direction. In an embodiment, the fixing jig 400 may be joined to ends of the ladder frame 110 in the Y-axis direction. A pair of fixing jigs 400 may be formed at ends of the base portion 111.

The fixing jig 400 may fix ends of the reel when the reel is suctioned by the rotary gripper and transferred to one end of the ladder frame 110. In an embodiment, the fixing jig 400 may be aligned in the Y-axis direction then rotated to be aligned in the X-axis direction when the reel is transferred to one end of the ladder frame 110.

When the reel is released from the reel supply portion and transferred to one end of the ladder frame 110, a force is generated to move in the opposite direction of the transfer direction due to tension, but the transferred state of the reel may be maintained through the fixing jig 400. In an embodiment, the fixing jig 400 may press the upper surface of the reel to fix the reel in position.

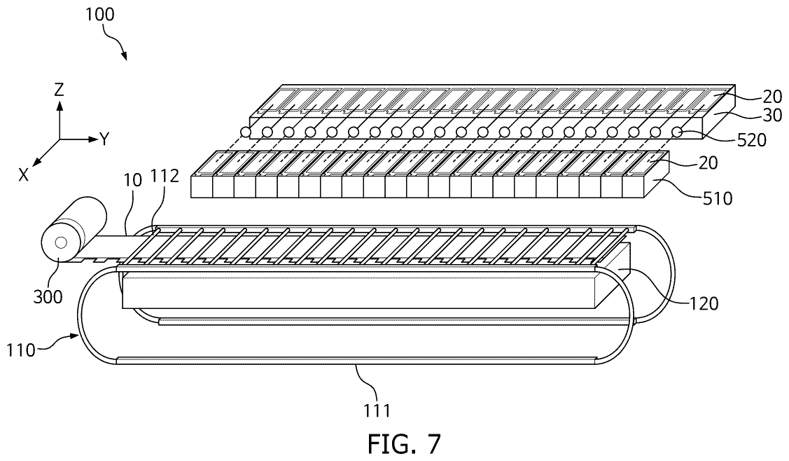

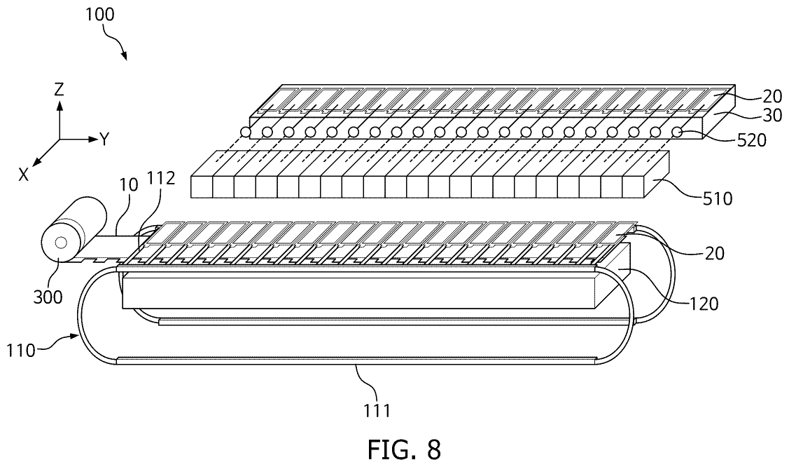

FIG. 7 shows the positive electrode plate 20 being transferred to an alignment table 510 in the secondary battery stacking device 100 according to embodiments of the present disclosure and FIG. 8 shows the positive electrode plate 20 positioned on the alignment table 510 in FIG. 7 being stacked on the reel 10 according to embodiments of the present disclosure.

Referring to FIGS. 7 and 8, the secondary battery stacking device may further include an alignment table 510 and a suction jig 520. The alignment table 510 may be positioned on one side of the stacking table 120 and may adjust the positions of a plurality of positive electrode plates 20 transferred from a conveyor 30 on which the positive electrode plates 20 are loaded.

In an embodiment, the positive electrode plates 20 transferred from the conveyor 30 on which the positive electrode plates 20 are loaded may be transferred to the alignment table 510 in the X-axis direction while maintaining a constant direction without being distorted through the suction jig 520. The suction jig 520 may transfer the positive electrode plates 20 arranged on the alignment table 510.

The positive electrode plates 20 may be aligned in the Y-axis direction. The suction jig 520 may be formed in plurality to correspond to the number of positive electrode plates 20 to be transferred. The suction jig 520 may stack the positive electrode plates 20 on the reel 10 positioned on the stacking table 120.

According to an embodiment of the present disclosure, the positive electrode plate 20 is transferred to the alignment table 510, correcting meandering through fine correction. When the positive electrode plates 20 are stacked on the reel 10 positioned on the stacking table 120, the positive electrode plates 20 have to be joined in an aligned state at the correct position so that the positive electrode plates 20 are not misaligned or joined with a step difference.

When any one electrode is laminated in a misaligned state while forming a diagonal line with respect to another electrode, defects such as short circuits may occur in protruding portions of the electrodes or portions where the positive and negative electrodes are separated, increasing the internal resistance of the battery. Therefore, in the present disclosure, the alignment table 510 may improve the stacking precision by allowing the positive electrode plate 20 and the reel 10 to be joined in an aligned state during the process of stacking the positive electrode plate 20 on the reel 10.

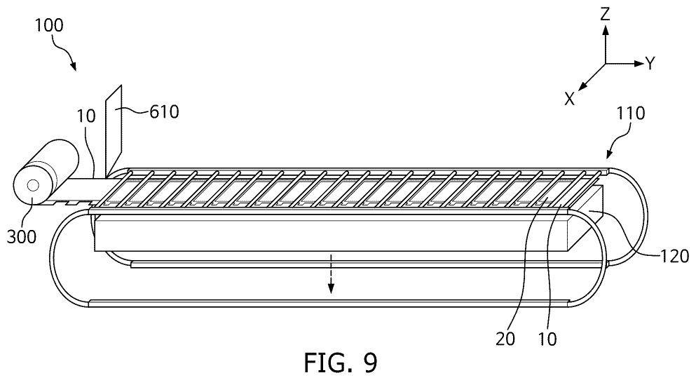

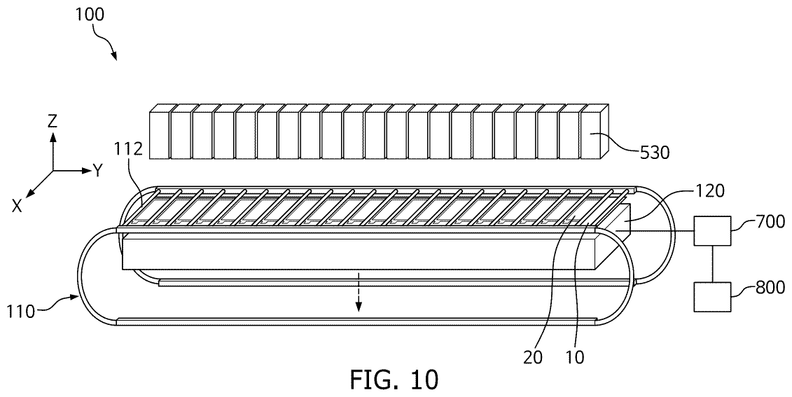

FIG. 9 shows a first cutting portion 610 in the secondary battery stacking device 100 according to embodiment of the present disclosure and FIG. 10 shows a pressurizing jig 530 in the secondary battery stacking device 100 according to embodiments of the present disclosure.

Referring to FIGS. 9 and 10, the secondary battery stacking device 100 may further include a driver 700 and a controller 800. The driver 700 may be connected to the stacking table 120 and apply a driving force to the stacking table 120. The controller 800 may be connected to the driver 700 and control the movement of the stacking table 120. In an embodiment, the driver 700 may be connected to all components that drive the secondary battery stacking device 100 and apply the driving force.

In an embodiment, the controller 800 may control the driver 700 to move the stacking table 120 to the lower end of the ladder frame 110 in response to the thickness of the reel 10 on which the positive electrode plates 20 are stacked. The stacking table 120 may be configured to descend in the Z-axis direction.

According to an embodiment, the secondary battery stacking device 100 may further include a first cutting portion 610. The first cutting portion 610 may be positioned above the ladder frame 110 adjacent to the reel supply portion 300. The first cutting portion 610 may cut one end of the reel 10 on which the positive electrode plates 20 are stacked. In an embodiment, the first cutting portion 610 may have a sharp blade shape at the end thereof.

The secondary battery stacking device 100 may further include a pressurizing jig 530. The pressurizing jig 530 may be aligned above the stacking table 120 at a predetermined interval and may descend between the bridge portions 112. In an embodiment, a plurality of pressurizing jigs 530 may be formed to correspond to the number of positive electrode plates 20. The pressurizing jig 530 may move downward in the Z-axis direction to pressurize the positive electrode plates 20 stacked on the reel 10. In an embodiment, the pressurizing jig 530 may laminate the positive electrode plates 20 to the reel 10 through thermal compression.

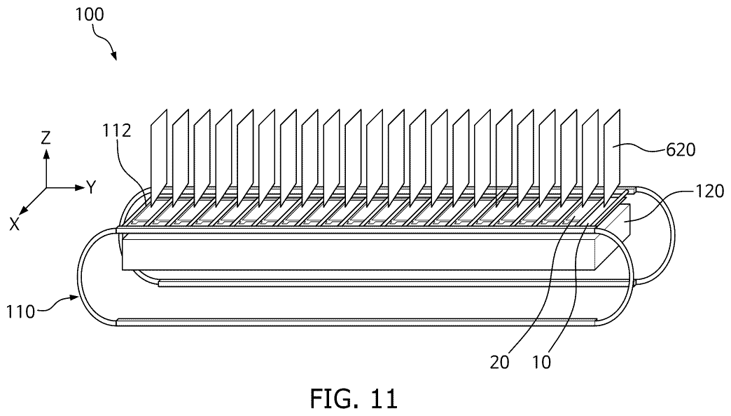

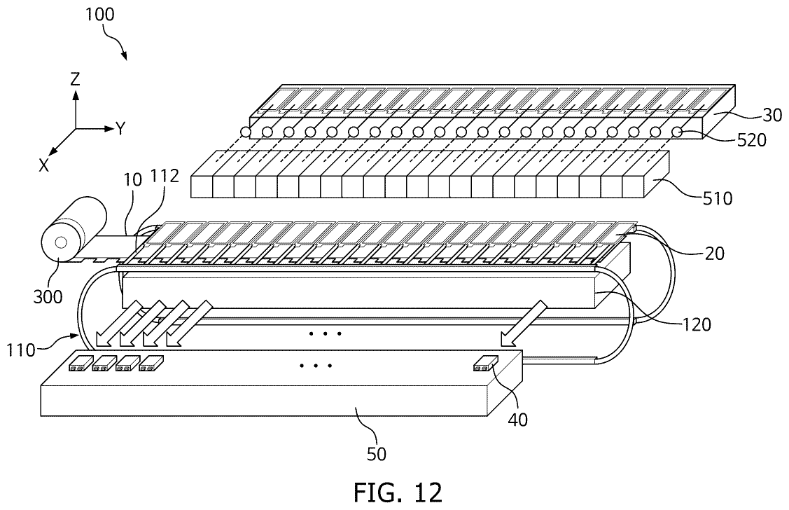

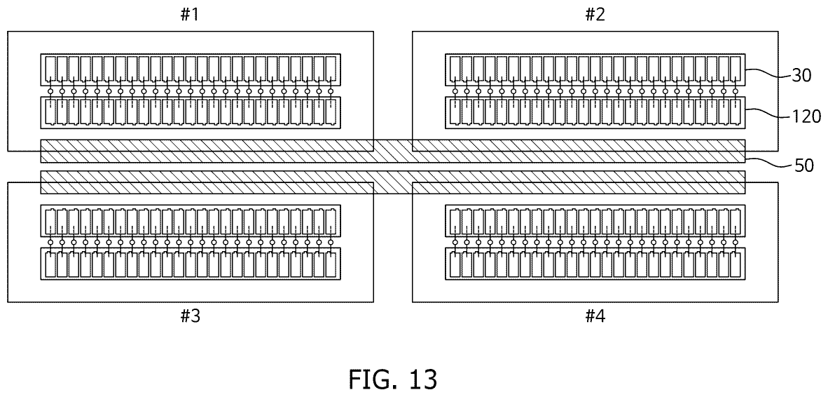

FIG. 11 shows a second cutting portion 620 in the secondary battery stacking device 100 according to embodiments of the present disclosure, FIG. 12 shows an electrode assembly 100 completed by being cut through the second cutting portion 620 of FIG. 11 according to embodiments of the present disclosure, and FIG. 13 shows a plurality of secondary battery stacking devices being arranged according to embodiments of the present disclosure.

Referring to FIGS. 11 to 13, the secondary battery stacking device 100 may further include a second cutting portion 620 positioned above the stacking table 120. The second cutting portion 620 may be aligned above the stacking table 120 at a predetermined interval. The second cutting portion 620 may descend in the Z-axis direction between the bridge portions 112 to cut the reel 10 at predetermined intervals.

In an embodiment, the second cutting portion 620 may descend in the Z-axis direction between the bridge portions 112 to cut the reel 10, to which the positive electrode plates 20 are laminated, at perdetermined intervals. The separation interval of the second cutting portion 620 in the Y-axis direction may be greater than the size of the positive electrode plate 20 in the Y-axis direction.

Referring to FIGS. 12 and 13, in the stacking process using the secondary battery stacking device 100, the final electrode assembly 40 that has undergone cutting may be moved to a transfer conveyor 50 through the conveyor 30 that supplies the positive electrode plate 20 and the ladder frame 110 on which the real 10 having the negative electrode plate and the separator formed thereon are positioned.

The final electrode assembly 40 may be moved to the transfer conveyor 50 and fed into a subsequent process. In an embodiment, the ladder frame 110 may be positioned on one side of the conveyor 30 that supplies the positive electrode plates 20, and the transfer conveyor 50 may be positioned on one side of the ladder frame 110, so that a plurality of final electrode assemblies 40 may be fed into the subsequent process.

In an embodiment, as shown in FIG. 13, two secondary battery stacking devices are arranged in parallel (#1 and #3, #2 and #4) and two secondary battery stacking devices are arranged in series (#1 and #2, #3 and #4), the final electrode assemblies 40 may be moved to the transfer conveyor 50, and thus, the speed of the stacking process may be improved.

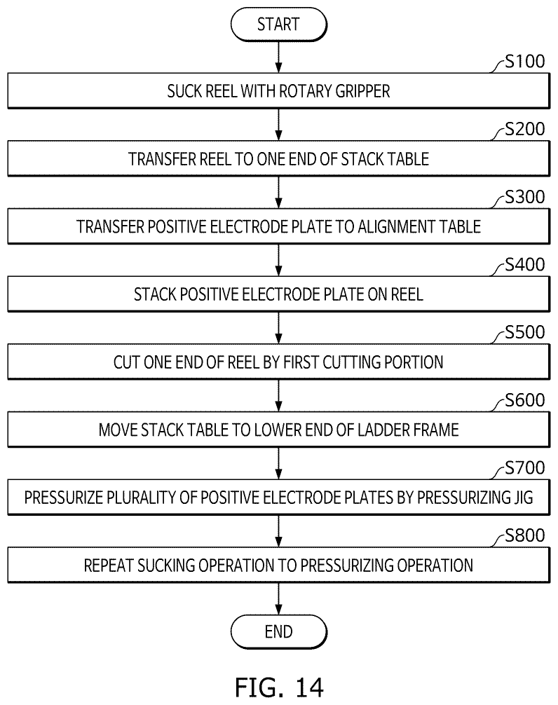

FIG. 14 is a flowchart showing a method for stacking a secondary battery according to embodiments of the present disclosure.

Referring to FIG. 14, the method may include suctioning a reel with a rotary gripper (S100), transferring the reel to one end of a stacking table (S200), transferring a positive electrode plate to an alignment table (S300), stacking the positive electrode plate on the reel (S400), cutting one end of the reel by a first cutting portion (S500), moving the stacking table to a lower end of a ladder frame (S600), pressurizing a plurality of positive electrode plates by a pressurizing jig (S700), and repeating the suctioning operation to the pressurizing operation (S800).

In the operation S100 of suctioning the reel with the rotary gripper, a reel supplied from a reel supply portion may be suctioned with the rotary gripper. The rotary gripper may include a gripper body portion having a guide groove into which a guide rail is inserted, and a suction portion formed on one side of the gripper body portion and suctioning the reel. In the operation S100 of suctioning the reel with the rotary gripper, the gripper body portion of the rotary gripper may rotate along the guide rail so that the gripper body portion may be restored to the other end of the ladder frame in a state in which the suction of the real is released from the suction portion.

In the operation S200 of transferring the reel, the rotary gripper can be moved along a guide rail formed on the ladder frame to transport the reel to one end of a stacking table provided on the ladder frame. In an embodiment, the operation S200 of transferring the reel S200 may include transferring the reel suctioned by the suction portion to one end of the ladder frame by moving the gripper body portion along the guide rail.

After the operation S200 of transferring the reel, the operation S300 of transferring the positive electrode plate to the alignment table and the operation S400 of stacking the positive electrode plate on the reel may be performed. In the operation S300 of transferring the positive electrode plates to the alignment table, the positive electrode plates may be transferred to the alignment table. Thereafter, in the operation S400 of stacking the positive electrode plates on the reel, the positive electrode plates may be stacked on the reel positioned on the stacking table through the suction jigs.

In an embodiment, before the operation S500 in which the first cutting portion cuts one end of the reel, the method may further include fixing opposite ends of the reel by using the fixing jig. The operation of fixing the reel may be performed by fixing opposite ends of the reel in a state in which the reel is transferred to one end of the ladder frame through the fixing jig joined to opposite ends of the ladder frame in the longitudinal direction.

In the operation S500 in which the first cutting portion cuts one end of the reel, the first cutting portion may cut one end of the reel on which the positive electrode plates are stacked. The operation S600 of moving the stacking table to the lower end of the ladder frame may include an operation in which the driver connected to the stacking table applied a driving force to the stacking table and an operation in which the controller connected to the driver controls the moving distance of the stacking table.

In the operation of controlling the moving distance of the stacking table, the controller may control the driver to move the stacking table to the lower end of the ladder frame in response to the thickness of the reel on which the positive electrode plates are stacked.

In the operation S700 in which the pressurizing jig pressurizes the positive electrode plates, a plurality of pressurizing jigs formed to correspond to the number of positive electrode plates may pressurize the positive electrode plates. In an embodiment, in the operation S700 of pressurizing the positive electrode plates, the pressurizing jig may be aligned above the stacking table at a predetermined interval and descend between the bridge portions of the stacking table to pressurize the positive electrode plates stacked on the reel.

After the operation S700 of pressurizing the positive electrode plates, an operation S800 of repeating the suctioning operation S100 to the pressurizing operation S700 may be performed. In a case where repeating the operation S100 of suctioning the reel with the rotary gripper to the operation S700 of pressurizing the positive electrode plates, a plurality of reel units having the positive electrode plates stacked thereon may be stacked. The method may further include, after the repeating operation S800 is performed, an operation in which the second cutting portions descend to cut the stacked reels at predetermined intervals.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

### DESCRIPTION OF NOTABLE REFERENCE SYMBOLS

10: reel
100: secondary battery stacking device
110: ladder frame
111: base portion
111a: guide rail
112: bridge portion
120: stacking table
200: rotary gripper
210: gripper body portion
211: guide groove
220: suction portion
300: reel supply portion
400: fixing jig
510: alignment table
520: suction jig
530: pressurizing jig
610: first cutting portion
620: second cutting portion
700: driver
800: controller

What is claimed is:

1. A secondary battery stacking device, comprising:
a stacking table configured to position a reel on the stacking table;
a ladder frame positioned above the stacking table and comprising a guide rail along a longitudinal direction;
a rotary gripper configured to suction the reel and move the reel along the guide rail; and
a reel supply portion configured to supply the reel.

2. The secondary battery stacking device as claimed in claim 1, wherein the ladder frame further comprises:
a base portion supporting the guide rail; and
a plurality of bridge portions positioned above the stacking table and spaced apart at predetermined intervals in the longitudinal direction.

3. The secondary battery stacking device as claimed in claim 1, wherein the rotary gripper comprises:
a gripper body portion comprising a guide groove corresponding to the guide rail; and
a suction portion positioned on one side of the gripper body portion and configured to suction the reel.

4. The secondary battery stacking device as claimed in claim 3, wherein the gripper body portion is configured to move along the guide rail to transfer the reel.

5. The secondary battery stacking device as claimed in claim 1, further comprising a fixing jig connected to longitudinal ends of the ladder frame and configured to fix the longitudinal ends of the reel.

6. The secondary battery stacking device as claimed in claim 1, further comprising:
a driver connected to the stacking table and configured to apply a driving force to the stacking table; and
a controller connected to the driver and configured to control movement of the stacking table.

7. The secondary battery stacking device as claimed in claim 6, wherein the stacking table moves to a lower end of the ladder frame in response to a thickness of the reel on which a positive electrode plate is stacked.

8. The secondary battery stacking device as claimed in claim 1, further comprising:
an alignment table positioned on one side of the stacking table and configured to adjust positions of a plurality of positive electrode plates transferred from a conveyor; and
a suction jig configured to transfer the plurality of positive electrode plates positioned on the alignment table and stack the positive electrode plates on the reel.

9. The secondary battery stacking device as claimed in claim 1, further comprising a first cutting portion positioned above the ladder frame at or adjacent to the reel supply portion and configured to cut the reel having a plurality of positive electrode plates stacked on the reel.

10. The secondary battery stacking device as claimed in claim 2, further comprising a plurality of pressurizing jigs aligned above the stacking table at predetermined intervals and configured to descend between the bridge portions to pressurize a plurality of positive electrode plates stacked on the reel.

11. The secondary battery stacking device as claimed in claim 2, further comprising a second cutting portion aligned above the stacking table at a predetermined interval and configured to descend between the plurality of bridge portions to cut the reel at a predetermined interval.

12. A method for stacking a secondary battery, comprising:
suctioning a reel supplied from a reel supply portion with a rotary gripper;
moving the rotary gripper along a guide rail formed on a ladder frame along a longitudinal direction to transfer the reel to one end of a stacking table;
transferring a plurality of positive electrode plates to an alignment table;
stacking the plurality of positive electrode plates on the reel positioned on the stacking table via a plurality of suction jigs;
cutting the reel having the positive electrode plates stacked on the reel;
causing the stacking table to move a lower end of the ladder frame; and
pressurizing the positive electrode plates.

13. The method as claimed in claim 12, further comprising, causing a plurality of second cutting portions to descend to cut the reel at predetermined intervals.

14. The method as claimed in claim 12, wherein the rotary gripper comprises:
a gripper body portion comprising a guide groove corresponding to the guide rail; and
a suction portion positioned on one side of the gripper body portion and configured to suction the reel.

15. The method as claimed in claim 14, wherein the transferring of the reel comprises moving the gripper body portion along the guide rail.

16. The method as claimed in claim 14, further comprising causing the gripper body portion to rotate along the guide rail.

17. The method as claimed in claim 12, further comprising, fixing longitudinal ends of the reel via a fixing jig joined to longitudinal ends of the ladder frame.

18. The method as claimed in claim 12, wherein, in the causing, a driver connected to the stacking table applies a driving force to the stacking table and a controller connected to the driver controls movement of the stacking table.

19. The method as claimed in claim 18, wherein the stacking table moves to the lower end of the ladder frame in response to a thickness of the reel on which the plurality of positive electrode plates is stacked.

20. The method as claimed in claim 12, wherein, in the pressurizing, a plurality of pressurizing jigs is aligned above the stacking table at predetermined intervals and configured to descend between a plurality of bridge portions of the stacking table to pressurize the plurality of positive electrode plates stacked on the reel.
